(19) United States
(12) Patent Application Publication
(10) Pub. No.: US 2026/0222805 A1
(43) Pub. Date: Jul. 30, 2026

(54) METHOD OF WIRELESS SECURITY COMMUNICATION USING PHYSICAL LAYER SHARED SECURITY KEY IN AMBIENT INTERNET-OF-THINGS NETWORK AND RELATED DEVICES

(71) Applicant: INNOPEAK TECHNOLOGY, INC., Palo Alto, CA (US)

(72) Inventor: Marcus WONG, Palo Alto, CA (US)

(73) Assignee: INNOPEAK TECHNOLOGY, INC., Palo Alto, CA (US)

(21) Appl. No.: 19/133,198

(22) PCT Filed: Dec. 1, 2023
(86) PCT No.: PCT/US2023/082008

§ 371 Date: May 27, 2025

Related U.S. Application Data
(60) Provisional application No. 63/429,432, filed on Dec. 1, 2022.

(51) Int. Cl. H04W 12/0471; H04L 9/08

(52) U.S. Cl. CPC H04W 12/0471; H04L 9/085

(57) ABSTRACT

A method of wireless security communication using a physical layer shared security key in an ambient internet-of-things (AIoT) network and related devices are proposed. In the method, a first node of the AIoT network performs generating a physical layer shared security key based on wireless channel reciprocity of communication between the first node and a second node of the AIoT network and additional information that is not derived from the wireless channel reciprocity; and exchanging a message using the physical layer shared security key with the second node. In this application, the shared security key generation can be achieved much faster, as compared to existing devices.

### CROSS-REFERENCE TO RELATED APPLICATIONS

This application claims the benefit of priority to U.S. Provisional Application No. 63/429,432, filed on Dec. 1, 2022, which is hereby incorporated in its entirety by this reference.

### TECHNICAL FIELD

The present application relates to wireless communication, and more particularly, to a method of wireless security communication using a physical layer shared security key in an ambient internet-of-things (AIoT) network and related devices.

### BACKGROUND

An ambient power-enabled Internet of Things device (IoT) is an IoT device powered by energy harvesting, being either battery-less or with limited energy storage capability (e.g., using a capacitor). 5G Ambient IoT (AIoT) service may support various use cases, such as automated warehousing, inventory management, smart grid, non-public logistics, manufacturing, IoT sensors, and smart home applications.

An AIoT device may be designed without a conventional battery. Instead, they are generally powered by energy harvesting. Energy harvested by AIoT devices typically relies on wireless radio waves, solar, light, motion/vibration, heat, pressure, or any other power sources. As a result, an AIoT device may communicate with a 5G UE or a 5G base station using power generated using energy harvesting. Security is important to protect network connections and data that could potentially be at risk of exposure and sabotage, even for low-or near-zero-powered device such as an AIoT. Other terminologies such as Passive IoT (PIoT), zero-powered IoT, low-powered IoT may be synonymous with AIoT.

Typical security can be provided by physical layer shared security key generation mechanism between the AIoT device and a user equipment (UE) (or a base station) that relies on the wireless channel reciprocity of communication between the two entities. The generated shared key then can be used to provide additional security services, e.g., such as ciphering and integrity protection of the communication between the two entities.

There are numerous techniques that rely on various characteristics of wireless channel reciprocity to derive shared keys between two communicating entities. Some of the characteristics used are signal strength, channel impulse response, channel state information, etc. Common bits are then extracted from combination of information, such as wireless channel information or parameter measurements only present in communication between the two entities and only the two entities in proximity are able to extract. Once a sufficient number of bits (e.g., 128 or 256) are extracted, these bits form a shared secret key and can be used by the two entities to protect the information being exchanged.

Several drawbacks are present in the physical layer security used in key generation in existing systems.

One drawback is the mechanism is mainly designed to address the problem of key distribution. Typical key distribution in any communication system relies on pre-provisioning of shared secret between the two communicating entities, for example, in 5G (and prior generation networks), a SIM card containing the shared key is handed to the user (during purchase, sent in mail, and sent over the air in the latest use of an electronic subscriber identification module (eSIM)), inserted in the handset). The same information is also input into the network entity. The distribution of subscriber identification module (SIM) requires large scaling to support billions of users. Physical layer security shared key generation does not require such a large-scale key distribution.

A second drawback is that existing systems are designed for devices with much more capabilities (e.g., with energy sources such as a battery, more computing capability such as chipset used in smart phones) than for ambient internet-of-things (IoT) (AIoT). The more power the device has, the easier it is to extract quality bits during the process of exchanging, and the longer the devices can communicate the more bits that can be generated.

For AIoT devices, there is lack of storage to store large amount of data (such as security keys). It is very difficult to pre-provision the devices with pre-shared secret in large scale (e.g., billions of devices). The devices are also of low cost that lack more advanced computing capabilities that are required security services such as hashing, encryption, etc. Typical communication cycle involves another device such as a UE or a base station start radiating energy (in the process of trying to communicate with the AIoT device). In the short period of time that the AIoT device is awaken, the AIoT device has to harvest sufficient energy to perform the task that is required of the device in a very short period of time, such as establishing communication channel, preparing content of the communication, and sending the communication in the established communication, and going offline. In addition, during the short period of time the AIoT device is active, it has to provide the needed security to protect the communication.

### SUMMARY

An objective of the present application is to provide a method of wireless security communication and a first node of an ambient internet-of-things (AIoT) network to address the existing problem(s) described above.

In a first aspect, some embodiments of the present application provide a method of wireless security communication applied to a first node of an ambient internet-of-things (AIoT) network, including: generating a physical layer shared security key based on wireless channel reciprocity of communication between the first node and a second node of the AIoT network and additional information that is not derived from the wireless channel reciprocity; and exchanging a message using the physical layer shared security key with the second node.

In a second aspect, some embodiments of the present application provide a first node of an ambient internet-of-things (AIoT) network, including at least one processor configured to: generate a physical layer shared security key based on wireless channel reciprocity of communication between the first node and a second node of the AIoT network and additional information that is not derived from the wireless channel reciprocity; and exchange a message using the physical layer shared security key with the second node.

In the present application, the first node 2 of AIoT network generates a physical layer shared security key based on wireless channel reciprocity of communication between the first node and the second node of the AIoT network and additional information that is not derived from the wireless channel reciprocity and exchanges a message using the physical layer shared security key with the second node. The physical layer shared security key is generated by providing additional information during communication so that the shared security key generation can be achieved much faster.

### DESCRIPTION OF DRAWINGS

In order to more clearly illustrate the embodiments of the present application or related art, the following figures that will be described in the embodiments are briefly introduced. It is obvious that the drawings are merely some embodiments of the present application, a person having ordinary skill in this field can obtain other figures according to these figures without paying the premise.

FIG. 1 is a schematic diagram illustrating an exemplary AIoT communication system.

FIG. 2 is a block diagram illustrating an AIoT network according to some embodiments of the present application.

FIG. 3 is a flowchart of a method of wireless security communication of a first node of an AIoT network according to some embodiments of the present application.

FIG. 4 is a schematic diagram illustrating hybrid physical layer key generation with additional input in a AIoT network according to some embodiments of the present application.

### DETAILED DESCRIPTION

Embodiments of the disclosure are described in detail with the technical matters, structural features, achieved objects, and effects with reference to the accompanying drawings as follows. Specifically, the terminologies in the embodiments of the present application are merely for describing the purpose of the certain embodiment, but not to limit the disclosure.

In this document, a combination such as “at least one of A, B, or C,” “one or more of A, B, or C,” “at least one of A, B, and C,” “one or more of A, B, and C,” or “A, B, and/or C” may be A only, B only, C only, A and B, A and C, B and C, or A and B and C, where any combination may contain one or more members of A, B, or C.

The present application provides wireless channel reciprocity for the generation of key(s). The key(s) is/are generated by providing additional information during communication so that the shared security key generation can be achieved much faster, as compared to other devices.

The present application provides a hybrid shared key generation mechanism that improves physical layer shared key generation by introducing additional parameters that are not derived from wireless channel reciprocity.

In some embodiments, once the key(s) is/are generated, it/they may be used as a one-time pad (OTP). The clear message (or information) to be protected is XORed with the OTP to form a ciphertext. The ciphertext is then sent over the air.

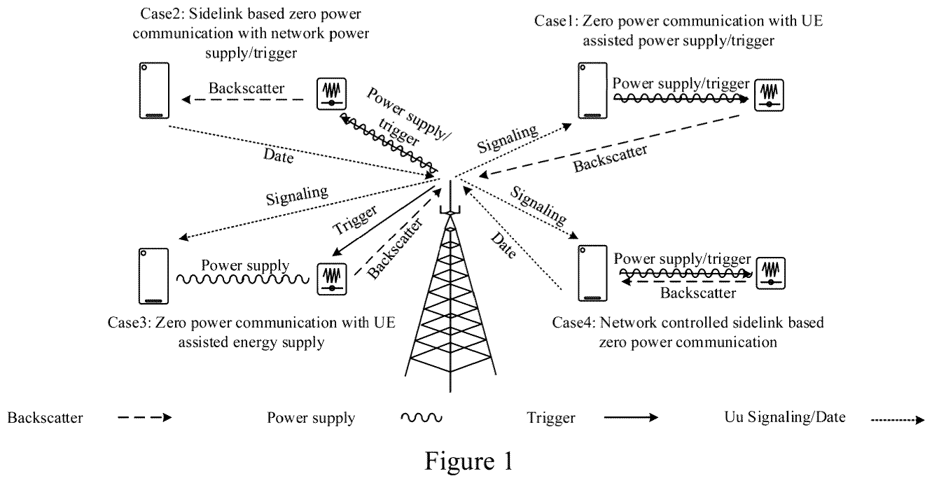

FIG. 1 is a schematic diagram illustrating an exemplary Ambient internet-of-things (AIoT) communication system. The AIoT communication system may include a base station (e.g., gNB in 5G), a user equipment (UE) and an AIoT device or tag. There are four scenarios shown in FIG. 1 that this application can apply to:
In Case 1 (zero power communication with UE assisted power supply/trigger), upon reception of a signaling from the base station, the UE supplies power to and/or triggers the AIoT device or tag to perform backscattering communications with the base station.
In Case 2 (sidelink based zero power communication with network power supply/trigger), the base station supplies power to and/or triggers the AIoT device or tag to perform backscattering communications with the UE, and the UE conveys the information received from the AIoT device or tag to the base station.
In Case 3 (zero power communication with UE assisted energy supply), the UE supplies power to the AIoT device or tag upon reception of a signaling from the base station, and the base station triggers the AIoT device or tag to perform backscattering communications with the base station.
In Case 4 (network controlled sidelink based zero power communication), upon reception of a signaling from the base station, the UE supplies power to and/or triggers the AIoT device or tag to perform backscattering communications with the UE, and the UE conveys the information received from the AIoT device or tag to the base station.

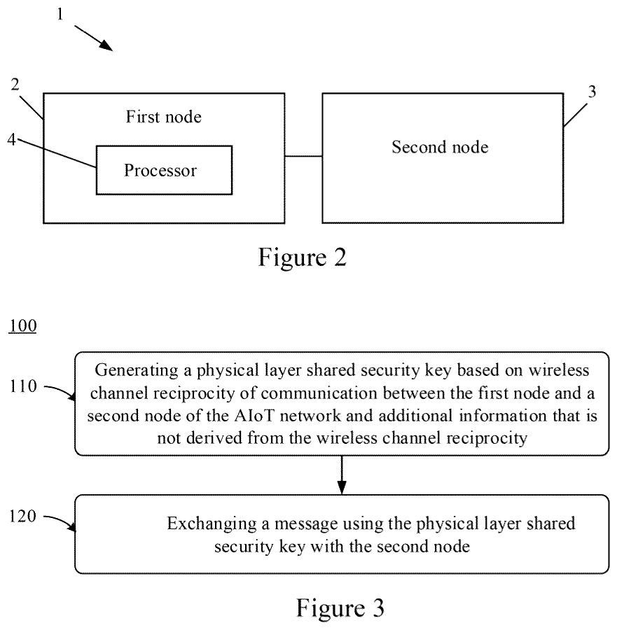

FIG. 2 is a block diagram illustrating an AIoT network 1 according to some embodiments of the present application. Referring to FIG. 2, the AIoT network 1 includes a first node 2 and a second node 3, where wireless security communication is established between the first node 2 and the second node 3. The first node 2 includes at least one processor 4 configured to generate a physical layer shared security key and exchange a message or information using the generated physical layer shared security key with the second node 3.

The second node 3 may perform the same or similar operations to generate the physical layer shared security key. The first node 2 may encrypt the message or information with the physical layer shared security key, and then the message or information is decrypted by the second node 3 using the physical layer shared security key generated on the second node 3. Alternatively, the second node 3 may encrypt the message or information using the physical layer shared security key, and then the message or information is decrypted by the first node 2 using the physical layer shared security key generated on the first node 2.

In some embodiments, the first node 2 is an AIoT device or tag, and the second node 3 is either a user equipment or a base station. In other embodiments, the first node 2 is either a user equipment or a base station, and the second node 3 is an AIoT device or tag.

In some embodiments, any of the four communication scenarios (i.e., Case 1 to Case 4) illustrated in FIG. 1 can be applied for the AIoT device or tag, the user equipment and the base station.

Specifically, the physical layer shared security key is generated based on wireless channel reciprocity of communication between the first node 2 and the second node 3 of the AIoT network 1 and additional information that is not derived from the wireless channel reciprocity. Further details for this are provided below.

As mentioned above, physical layer shared security key generation between the AIoT device or tag and a UE (or a base station) relies on the wireless channel reciprocity of communication between the two entities. The characteristics of wireless channel reciprocity to derive the shared key between the two communicating entities includes, but is not limited to, signal strength (e.g., reference signal strength (RSS)), channel impulse response (CIR), channel state information (CSI), and etc.

Using characteristics based on wireless channel reciprocity may require multiple of channel probing, channel measurements, and channel tuning between the two entities in order to extract common bits. If the extracted common bits are used as long-term shared secret, multiples of 128 bits (e.g., 128 or 256 bits) are required. Since the process of extracting common bits is slow, this may require several iterations to extract the required bits. It is a time-consuming luxury that AIoT devices do not have.

In this application, during the present AIoT communication cycle, and in the process of communication channel establishment, additional information is input in order to generate the physical layer shared security key. For instance, the additional information may be injected into a randomness generation process (i.e., randomization process). Some examples of the additional information that can be injected in the randomness generation process (i.e., randomization process) are:
1. additional nonce (can be sent during channel establishment);
2. system time (can be rough system time kept locally or time that may be needed for channel synchronization);
3. counter (can be sent during channel establishment);
′4. device identifier (only known to the device and UE/BS);
5. serial number (only known to the device and UE/BS); and
6. other relevant information.

In the randomization process, the characteristics of wireless channel reciprocity and the additional information may be randomly selected to extract the common bits in the process of physical layer shared security key generation. Which information has been selected in the randomization process to extract the common bits may be communicated between the device and UE/BS.

By adding additional information to the randomization process, fewer iterations are required to extract the same number of required bits for use as shared key (or for use as key stream). Using parameters in key generation is a practice that does not degrade the security of the keys being generated. Therefore, with additional input to the randomization process, the security and quality of keys generated based on channel reciprocity also do not degrade.

In some embodiments, the physical layer shared security key may be used as a one-time pad (OTP). In addition, the at least one processor 4 of the first node 2 may perform an XOR operation on a clear message or information to be protected by using the OTP to form a ciphertext. The ciphertext may then be sent to the second node 3 of the AIoT network 1 over the air.

FIG. 3 is a flowchart of a method 100 of wireless security communication applied to a first node 2 of an AIoT network 1 according to some embodiments of the present application. The method 100 can be applied in the scenarios (i.e., Case 1 to Case 4) illustrated in FIG. 1. Referring to FIG. 3 in conjunction with FIG. 2, the method 100, performed by the first node 2 (or the second node 3) of the AIoT network 1, includes the following steps.

In Step 110, the at least one processor 4 of the first node 2 generates a physical layer shared security key based on wireless channel reciprocity of communication between the first node 2 and a second node 3 of the AIoT network 1 and additional information that is not derived from the wireless channel reciprocity.

The characteristics of wireless channel reciprocity used to generate physical layer shared security key between the first node 2 and the second node 3 of the AIoT network may include reference signal strength (RSS), channel impulse response (CIR), channel state information (CSI), and etc. Both the first node 2 and the second node 3 of the AIoT network are aware of such information in the process of channel establishment between the two communicating entities.

‘In addition to the characteristics of wireless channel reciprocity, additional information that is not derived from the wireless channel reciprocity is also involved in generating the physical layer shared security key. The additional information includes, but is not limited to, additional nonce, system time, counter, device identifier, serial number, etc. The first node 2 and the second node 3 may communicate with each other during channel establishment to obtain the information of additional nonce and counter. This may increase security as compared to transmitting such information after the channel establishment, where security communication has not been established between the two communicating entities. The device identifier or serial number of the first node 2 may have been known to the second node 3. For example, the AIoT device or tag can have its device identifier or serial number stored on a storage thereof, and the UE/BS may know such information at the time the AIoT device or tag is registered. The system time may be rough system time kept on both the first node 2 and the second node 3 or that is synchronized between the two nodes 2 and 3 via channel synchronization.

The above-mentioned two types of information may be then fed into a randomization process. In the randomization process, the characteristics of wireless channel reciprocity and the additional information are randomly selected for the generation of physical layer shared security key. That is, some of them will be selected randomly for extracting common bits therefrom to generate the physical layer shared security key. Which information has been selected in the randomization process may be communicated between the first node 2 and the second node 3. The random selection may be performed on one of the two nodes 2 and 3, which may then communicate to the other which information has been selected. Alternatively, it is also possible for both the two nodes 2 and 3 to perform the random selection. Then, the two nodes 2 and 3 communicate with each other which information has been selected by themselves. The common information both the two nodes 2 and 3 select is for extracting the common bits to generate the physical layer shared security key.

In Step 120, the at least one processor 4 of the first node 2 exchanges a message using the physical layer shared security key with the second node 3.

The second node 3 may perform similar or the same processes to generate a physical layer shared security key, which is the same as the physical layer shared security key generated by the first node 2. Then, the first node 2 may encrypt a message using the physical layer shared security key generated by the first node 2 and deliver the encrypted message to the second node 3, and the second node 3 may then decrypt the encrypted message using the physical layer shared security key generated by the second node 3. Therefore, the message can be transmitted and received via a protected communication link between the first node 2 and the second node 3.

In the present application, the first node 2 of AIoT network generates a physical layer shared security key based on wireless channel reciprocity of communication between the first node and the second node of the AIoT network and additional information that is not derived from the wireless channel reciprocity and exchanges a message using the physical layer shared security key with the second node. The physical layer shared security key is generated by providing additional information during communication so that the shared security key generation can be achieved much faster.

Further details of the method 100 can be referred to other content of this disclosure, which will not be repeated herein.

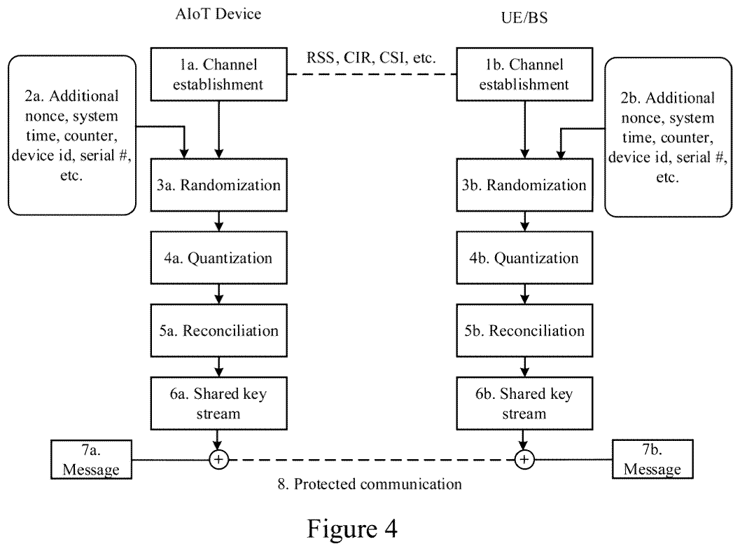

FIG. 4 is a schematic diagram illustrating hybrid physical layer key generation with additional input in a AIoT network according to some embodiments of the present application. It is noted that the same or similar operations are performed by the AIoT device and the UE (or the base station) to generate the physical layer shared security key and exchange a message using the physical layer shared security key.

Referring to FIG. 4, channel establishment 1a and 1b is performed by the AIoT device and the UE (or the base station). Various characteristics of wireless channel reciprocity, such as RSS, CIR, CSI, and etc., are communicated between the two entities. The characteristics of wireless channel reciprocity and additional information from Steps 2a and 2b, such as additional nonce, system time, counter, device id, serial number and etc., are injected into randomization processes 3a and 3b, respectively.

In the randomization processes 3a and 3b, the characteristics of wireless channel reciprocity and the additional information may be randomly selected for the generation of physical layer shared security key. Following the randomization 3a and 3b, quantization 4a and 4b and reconciliation 5a and 5b are performed. Various randomization, quantization, and reconciliation techniques can be used in this hybrid physical layer shared key generation mechanism, depending on the implementation. Randomization 3a and 3b can introduce randomness into the key generation process, making it more difficult for an attacker to predict or reproduce the key. Quantization 4a and 4b involves discretizing continuous signal values into a finite set of levels, and it simplifies the signal information to a form that can be used for key generation, making it computationally feasible. The primary role of reconciliation 5a and 5b in the generation of physical layer shared security key is to address and correct discrepancies between the key sequences generated at different locations. It is noted that these processes (i.e., randomization 3a and 3b, quantization 4a and 4b and reconciliation 5a and 5b) are known in the art and are not detailed herein.

In Steps 6a and 6b, shared key streams are generated. The AIoT device may encrypt a message from Step 7a using the shared key stream 6a and deliver the encrypted message via the protected communication 8, and the UE (or the base station) may then decrypt it using the shared key stream 6b to obtain a clear message. Also, the UE (or the base station) may encrypt a message from Step 7b using the shared key stream 6b and deliver the encrypted message via the protected communication 8, and the AIoT device may then decrypt it using the shared key stream 6a to obtain a clear message.

The present hybrid physical layer shared key generation benefits the security of communication between AIoT device and UE/base station in many ways.

First, it reduces the time used to communicate between AIoT device and the UE/base station when compared to existing AIoT devices in order to derive the same number of bits that can be used as shared key.

Second, the shared key extracted using the present techniques can be used as a one-time pad (OTP), which protects the information being sent from AIoT device to the UE/base station. OTP provides a very security in that the key stream to protect the communication is not repeated, thereby eliminating attacks that involve collecting and comparing between cipher-text and clear-text pairs.

Third, use of OTP does not require AIoT devices with power-intensive operations such as hashing or ciphering. Each message (e.g., information being sent) is protected by applying exclusive-or operation to the message and the OTP.

As an alternative to hybrid physical layer key generation in an AIoT communication system, a less efficient physical layer key generation may be used. For instance, instead of an OTP for protecting the communication in an AIoT communication system, a shared key in traditionally compute-intensive ciphering or hashing operations that require large-number computation may be used, in some embodiments.

The embodiment of the present application further provides a computer readable storage medium for storing a computer program. The computer readable storage medium enables a computer to execute corresponding processes implemented in each of the methods of the embodiments of the present application. For brevity, details will not be described herein again.

The embodiment of the present application further provides a computer program product including computer program instructions. The computer program product enables a computer to execute corresponding processes implemented in each of the methods of the embodiments of the present application. For brevity, details will not be described herein again.

The embodiment of the present application further provides a computer program. The computer program enables a computer to execute corresponding processes implemented in each of the methods of the embodiments of the present application. For brevity, details will not be described herein again.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both.

To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

It should be understood that any embodiments disclosed herein as being “non-transitory” do not exclude any physical storage medium, but rather exclude only the interpretation that the medium can be construed as a transitory propagating signal.

The elements and components of an embodiment of the invention may be physically, functionally and logically implemented in any suitable way. Indeed, the functionality may be implemented in a single unit, in a plurality of units or as part of other functional units. Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

Above all, while the preferred embodiments of the present application have been illustrated and described in detail, various modifications and alterations can be made by persons of ordinary skill in the art. The embodiment of the present application is therefore described in an illustrative but not restrictive sense. It is intended that the present application should not be limited to the particular forms as illustrated, and that all modifications and alterations which maintain the spirit and realm of the present application are within the scope as defined in the appended claims.

1. A method of wireless security communication applied to a first node of an ambient internet-of-things (AIoT) network, the method comprising:
generating, by the first node, a physical layer shared security key based on wireless channel reciprocity of communication between the first node and a second node of the AIoT network and additional information that is not derived from the wireless channel reciprocity; and
exchanging, by the first node, a message using the physical layer shared security key with the second node.

2. The method of claim 1, wherein the first node is an AIoT device, and the second node is either a user equipment or a base station.

3. The method of claim 1, wherein the first node is either a user equipment or a base station, and the second node is an AIoT device.

4. The method of claim 1, wherein characteristics of the wireless channel reciprocity comprise at least one of signal strength, channel impulse response and channel state information.

5. The method of claim 1, wherein the additional information comprises at least one of additional nonce, system time, counter, device identifier and serial number,

6. The method of claim 1, wherein characteristics of the wireless channel reciprocity and the additional information are input to a randomization process in order to generate the physical layer shared security key.

7. The method of claim 1, wherein the physical layer shared security key is for use as a key stream.

8. The method of claim 1, wherein the physical layer shared security key is used as a one-time pad (OTP).

9. The method of claim 8, wherein before the exchanging a message using the physical laver shared security key with the second node, the method further comprises:
performing, by the first node, an exclusive-or (XOR) operation on a clear message or information to be protected by using the OTP to form a ciphertext.

10. A first node of an ambient internet-of-things (AIoT) network, comprising at least one processor configured to:
generate a physical layer shared security key based on wireless channel reciprocity of communication between the first node and a second node of the AIoT network and additional information that is not derived from the wireless channel reciprocity; and
exchange a message using the physical layer shared security key with the second node.

11. The first node of claim 10, wherein the first node is an AIoT device, and the second node is either a user equipment or a base station.

12. The first node of claim 10, wherein the first node is either a user equipment or a base station, and the second node is an AIoT device.

13. The first node of claim 10, wherein characteristics of the wireless channel reciprocity comprise at least one of signal strength, channel impulse response and channel state information.

14. The first node of claim 10, wherein the additional information comprises at least one of additional nonce, system time, counter, device identifier and serial number.

15. The first node of claim 10, wherein characteristics of the wireless channel reciprocity and the additional information are input to a randomization process in order to generate the physical layer shared security key.

16. The first node of claim 10, wherein the physical layer shared security key is for use as a key stream.

17. The first node of claim 10, wherein the physical layer shared security key is used as a one-time pad (OTP).

18. The first node of claim 17, wherein the at least one processor is further configured to:
perform an exclusive-or (XOR) operation on a clear message or information to be protected by using the OTP to form a ciphertext.

19. A non-transitory computer readable storage medium for storing a computer program that, when executed by a computer, causes the computer to perform the following:
generating a physical layer shared security key based on wireless channel reciprocity of communication between the first node and a second node of an ambient internet-of-things (AIoT) network and additional information that is not derived from the wireless channel reciprocity; and
exchanging a message using the physical layer shared security key with the second node.

20. The non-transitory readable storage medium of claim 19, wherein the additional information comprises at least one of additional nonce, system time, counter, device identifier and serial number.
